(19) United States
(12) Patent Application Publication
(10) Pub. No.: US 2009/0190620 A1
(43) Pub. Date: Jul. 30, 2009

(54) OPTICAL DISK DEVICE AND METHOD OF CONTROLLING LIGHT EMITTING ELEMENT

(75) Inventor: Hirokazu SHOU, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/245,159

(22) Filed: Oct. 3, 2008

(30) Foreign Application Priority Data
Jan. 28, 2008 (JP) 2008015834

(51) Int. Cl. H01S 3/10; G11B 9/10

(52) U.S. Cl. 372/38.02; 372/38.07; 369/100; G9B/9.025

(57) ABSTRACT

An optical disk device includes: a light emitting element which applies light to an optical disk; a light detection unit which receives the light emitted from the light emitting element and outputs an intensity signal corresponding to an intensity of the light emitting element; a difference detection unit which generates a control signal based on a difference between the intensity signal and a reference intensity signal; a first current supply unit which supplies a first current based on the control signal; a second current supply unit which supplies a second current; a current adding unit which adds the first and second currents to generate a third current and supplies the third current to the light emitting element; an optical pickup on which the first current supply unit and the adding unit are placed; and a circuit board on which the second current supply unit is placed.

### CROSS-REFERENCE TO THE INVENTION

This application is based upon and claims the benefit of priority from the prior Japanese Patent Application No. 2008-015834, filed on Jan. 28, 2008; the entire contents of which are incorporated herein by reference.

### BACKGROUND OF THE INVENTION

1. Field of the Invention

The present invention relates to an optical disk device and a method of controlling a light emitting element.

2. Description of the Related Art

A technique relating to an optical disk drive is disclosed in which the power consumption in a laser drive unit is kept constant by controlling the intensity of the laser light constant (see JP-A 2003-168232(KOKAI)). The loss in the laser drive circuit can be reduced, and the power consumption and temperature rise in the optical pickup can be reduced.

### BRIEF SUMMARY OF THE INVENTION

In the above-described optical disk, a laser drive current is consumed in the laser drive circuit here. Therefore, the power consumption in the optical pickup is proportional to the drive current and therefore the power consumption cannot be reduced any more.

In consideration of the above circumstances, an object of the present invention is to provide an optical disk device and a method of controlling a light emitting element, each capable of effectively reducing the power consumption in an optical pickup.

An optical disk device according to an aspect of the present invention includes: a light emitting element which applies light to an optical disk; a light detection unit which receives the light emitted from the light emitting element and outputs an intensity signal corresponding to an intensity of the light emitting element; a difference detection unit which generates a control signal based on a difference between the intensity signal and a reference intensity signal; a first current supply unit which supplies a first current based on the control signal; a second current supply unit which supplies a second current; a current adding unit which adds the first and second currents to generate a third current and supplies the third current to the light emitting element; an optical pickup on which the first current supply unit and the adding unit are placed; and a circuit board on which the second current supply unit is placed.

A method of controlling a light emitting element according to an aspect of the present invention is a method of controlling a light emitting element which applies light to an optical disk, including: receiving the light emitted from the light emitting element and outputting an intensity signal corresponding to an intensity of the light emitting element; generating a control signal based on a difference between the intensity signal and a reference intensity signal; supplying a first current based on the control signal from top of an optical pickup; supplying a second current from top of a circuit board; and adding the first and second currents to generate a third current on top of the optical pickup and supplying the third current to the light emitting element.

### BRIEF DESCRIPTION OF THE DRAWINGS

FIG. 1 is a circuit diagram showing a configuration of a laser drive circuit 100 according to an embodiment of the present invention

FIG. 2 is a circuit diagram showing a configuration of a laser drive circuit 100x according to a comparison example of the present invention

FIG. 3 is a graph showing the drive current Ild-intensity Ald characteristic (light emission characteristic) of laser diodes LD1 to LD3

FIG. 4 is a flowchart showing an example of an operation procedure from turn-on to turn-off of the laser diode LD1 to LD3

FIG. 5 is a flowchart showing an example of the operation procedure from turn-on to turn-off of the laser diode LD1 to LD3

FIG. 6 is a flowchart showing an example of details of the turn-on procedure of the laser diode LD1 to LD3

FIG. 7 is a flowchart showing an example of an adjustment procedure for a bias current Ib

FIG. 8 is a flowchart showing an example of the adjustment procedure for the bias current Ib

FIG. 9 is a flowchart showing an example of the adjustment procedure for the bias current Ib

### DETAILED DESCRIPTION OF THE INVENTION

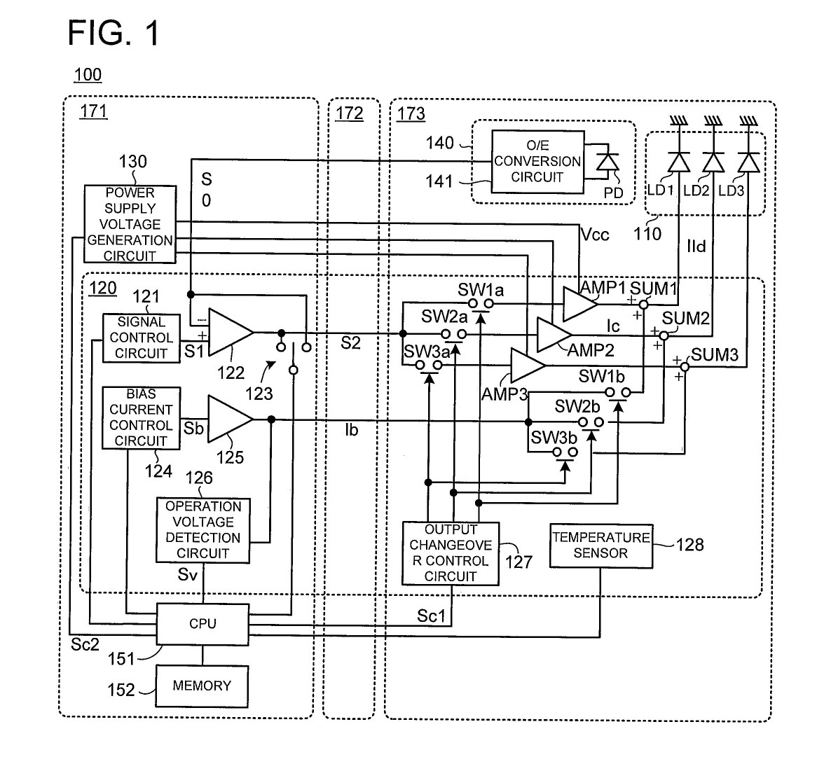

Hereinafter, embodiments of the present invention will be described in detail. FIG. 1 is a circuit diagram showing a configuration of a laser drive circuit 100 according to an embodiment of the present invention. The laser drive circuit 100 is mounted on an optical disk device and has a laser light source 110, a laser control circuit 120, a power supply voltage generation circuit 130, an O/E (optical/electric) converter 140, a CPU (Central Processing Unit) 151, and a memory 152. These are arranged on a PCB (printed circuit board) 171, an FPC (flexible printed circuit) 172, and an optical pickup 173 in the optical disk device.

The laser light source 110 has laser diodes LD1 to LD3 and applies laser light to an optical disk (for example, a CD (Compact Disk), a DVD (Digital Versatile Disk), and an HD-DVD (High Definition DVD). More specifically, the laser diodes LD1 to LD3 function as light emitting elements which apply lights to the optical disks.

The laser diodes LD1 to LD3 are individually driven by a drive current Ild supplied from the laser control circuit 120 to generate laser lights having different wavelengths. For example, corresponding to the CD, DVD, and HD-DVD, the laser diodes LD1 to LD3 emit infrared, red, and blue-violet laser lights, respectively.

The laser control circuit 120 supplies the drive current Ild to the laser diodes LD1 to LD3. The drive current Ild is generated by adding a bias current Ib and a control current Ic. The laser control circuit 120 has a signal control circuit 121, an error detection circuit 122, a changeover switch 123, a bias current control circuit 124, a current amplification circuit 125, an operation voltage detection circuit 126, current amplification and drive circuits AMP1 to AMP3, bias current adding circuits SUM1 to SUM3, switches SW1a to SW3a and SW1b to SW3b, an output changeover control circuit 127, and a temperature sensor 128.

The signal control circuit 121 is controlled by the CPU 151 to output a reference intensity signal S1 that is a comparison object (reference) of a detected intensity signal S0 outputted from the O/E converter 140. Based on the reference intensity signal S1, a current control signal S2 and thus the control current Ic and the drive current Ild are controlled. Since the voltage of the detected intensity signal S0 indicates an intensity Ald of the laser diodes LD1 to LD3 as described later, the voltage value of the reference intensity signal S1 indicates a target intensity At.

The error detection circuit 122 compares the detected intensity signal S0 outputted from the O/E converter 140 to the reference intensity signal S1 and outputs the current control signal S2 so that the difference (error) between them becomes 0. More specifically, the error detection circuit 122 functions as a difference detection unit which generates a control signal based on the difference between the intensity signal and the reference intensity signal.

More specifically, the error detection circuit 122 controls the laser light source 110 so that the detected intensity signal S0 (the intensity Ald of the laser light emitted from the laser light source 110) coincides with the reference intensity signal S1 (the reference intensity At). More specifically, when the detected intensity signal S0 is smaller than the reference intensity signal S0, the current control signal S2 and thus the drive current Ild increase. On the other hand, when the detected intensity signal S0 is larger than the reference intensity signal S1, the current control signal S2 and thus the drive current Ild decrease. With an increase/decrease of the current control signal S2, the intensity Ald from the laser diodes LD1 to LD3 is increased or decreased and thereby approaches the reference intensity At. When the detected intensity signal S0 is equal to the reference intensity signal S1 (when the intensity Ald coincides with the reference intensity At), the current control signal S2 is kept constant.

As described later, the current control signal S2 is amplified by the current amplification and drive circuits AMP1 to AMP3 to form the control current Ic. In other words, the current value itself of the current control signal S2 is the control amount by which the current amplification and drive circuits AMP1 to AMP3 are controlled.

The changeover switch 123 is a switch for selecting which of the detected intensity signal S0 or the current control signal S2 the CPU 151 detects.

The bias current control circuit 124 is controlled by the CPU 151 to output a bias current reference signal Sb being the reference of the bias current Ib. The current amplification circuit 125 functions as the current source to amplify the bias current reference signal Sb so as to generate the bias current Ib. The increase in the bias current Ib can decrease the control current Ic, thereby reducing the power consumption in the current amplification and drive circuits AMP1 to AMP3 and thus the power consumption in the optical pickup 173. The current amplification circuit 125 functions as a second current supply unit which supplied a second current.

When the laser diodes LD1 to LD3 continues turn-on state (for example, when reading out from the optical disk), the power consumption in the current amplification and drive circuits AMP1 to AMP3 can be significantly reduced by bringing the most of the drive current Ild to the bias current Ib. On the other hand, when blinking the laser diodes LD1 to LD3 (for example, when writing to the optical disk), it is preferable in terms of driving the laser diodes LD1 to LD3 to bring the bias current Ib to about a threshold current (an oscillation threshold value) or less of the laser diodes LD1 to LD3. Therefore, it is conceivable to set an optimal value (for example, a later-described bias current Ib_opt) to the bias current Ib.

The operation voltage detection circuit 126 converts a voltage Vb at the output end of the current amplification circuit 125 into an operation voltage detected signal Sv so that it can be read by the CPU 151. The voltage Vb corresponds to an operation voltage Vld of the laser diodes LD1 to LD3. Therefore the operation voltage detection circuit 126 functions as a voltage detection unit which detects the operation voltage of the light emitting elements.

Precisely, the voltage Vb is nearly equal to a voltage made by adding the voltage Vs (for example, a later-described forward voltage of a Schottky diode) in the bias current adding circuits SUM1 to SUM3 to the operation voltage Vld (Vb=Vld+Vs). Though this voltage Vs is applied as the offset voltage to a signal line through which the bias current Ib flows, a voltage corresponding to the operation voltage Vld of the laser diodes LD1 to LD3 is generated. In other words, the CPU 151 can detect the voltage Vb and thus the operation voltage Vld by the operation voltage detection circuit 126.

The current amplification and drive circuits AMP1 to AMP3, which correspond to the laser diodes LD1 to LD3 respectively, amplify the current control signal S2 by a power supply voltage Vcc supplied from the power supply voltage generation circuit 130 to generate the control current Ic. The current amplification and drive circuits AMP1 to AMP3 function as first current supply units which supply a first current based on the control signal.

The bias current adding circuits SUM1 to SUM3, which correspond to the laser diodes LD1 to LD3 respectively, add the bias current Ib to the control current Ic and output the drive current Ild (Ild=Ic+Ib). In other words, the bias current adding circuits SUM1 to SUM3 function as current adding units which add the first and second currents to generate a third current and supply it to the light emitting elements.

The bias current adding circuits SUM1 to SUM3 here include blocking devices, such as Schottky diodes on their input end sides on the current amplification circuit 125 side. This is to prevent the control current Ic from flowing into the current amplification circuit 125 side (to flow all the control current Ic into the laser diodes LD1 to LD3). For example, when the bias current Ib is small, the control current Ic flows into the current amplification circuit 125 side to cause a decrease in the intensity Ald of the laser diodes LD1 to LD3 or the like. Note that such blocking devices may be provided not in the bias current addition circuits SUM1 to SUM3 but in the current amplification circuit 125.

The switches SW1a to SW3a and SW1b to SW3b are controlled by the output changeover control circuit 127 to changeover between the laser diodes LD1 to LD3 to be supplied with the drive current Ild. The switches SW1a to SW3 select one of the current amplification and drive circuits AMP1 to AMP3 to which the current control signal S2 is inputted. The switches SW1 to SW3 select one of the bias current addition circuits SUM1 to SUM3 to which the bias current Ib is inputted.

The output changeover control circuit 127 controls the switches SW1a to SW3a and SW1b to SW3b in response to an output changeover control signal Sc1 from the CPU 151 to changeover between the laser diodes LD1 to LD3 to be supplied with the drive current Ild. For example, when the switches SW1a and SW1b are turned ON and the switches SW2a, SW3a, SW2b and SW3b are turned OFF, the laser diode LD1 is driven.

The temperature sensor 128, which is, for example, a thermistor, measures a temperature T of the optical pickup 173, in particular, near the laser diodes LD1 to LD3. The temperature T is used for judgment whether or not the bias current Ib needs to be adjusted.

The power supply voltage generation circuit 130 generates the power supply voltage Vcc corresponding to the power supply voltage control signal Sc2 from the CPU 151 and supplies it to the current amplification and drive circuits AMP1 to AMP3.

The O/E converter 140 functions as a light detection unit which receives the light emitted from the light emitting element and outputs the intensity signal corresponding to the intensity of the light emitting element. The O/E converter 140 has a photo detector PD and an O/E conversion circuit 141. The photo detector PD, which is, for example, a photo diode, receives the laser light from the laser light source 110 and generates a detected intensity current. The O/E conversion circuit 141 converts the detected intensity current into the detected intensity signal S0 via current-voltage conversion. In other words, the voltage of the detected intensity signal S0 indicates the intensity Ald of the laser diodes LD1 to LD3.

The CPU 151 receives the operation voltage detected signal Sv (information on the operation voltage Vld of the laser diodes LD1 to LD3) inputted from the operation voltage detection circuit 126. The CPU 151 receives the signal (the detected intensity signal S0, the current control signal S2) inputted from the changeover switch 123. The CPU 151 receives information on the temperature T of the optical pickup 173 inputted from the temperature sensor 128.

The CPU 151 outputs the power supply voltage control signal Sc2 and the output changeover control signal Sc1 to the power supply voltage generation circuit 130 and the output changeover control circuit 127 respectively. In other words, the CPU 151 controls the power supply voltage Vcc outputted from the power supply voltage generation circuit 130 by the power supply voltage control signal Sc2. As has been described, the CPU 151 can detect the operation voltage Vld of the laser diodes LD1 to LD3 by the operation voltage detected signal Sv. The CPU 151 calculates a later-described optimal power supply voltage Vcc_opt (an optimal power supply voltage Vcc) from the operation voltage vld. The CPU 151 conducts a control such that the power supply voltage Vcc becomes the optimal power supply voltage Vcc_opt by the power supply voltage control signal Sc2. As a result of this, a power consumption Pamp in the current amplification and drive circuits AMP1 to AMP3 is reduced.

The CPU 151 controls the signal control circuit 121 and the bias current control circuit 124. As a result, the CPU 151 can detect setting values of the signal control circuit 121 and the bias current control circuit 124 (for example, the reference intensity signal S1 outputted from the signal control circuit 121).

The CPU 151 also controls the output changeover control circuit 127 to changeover between the laser diodes LD1 to LD3 to be supplied with the drive current Ild.

The CPU 151 functions as the following elements:
a voltage control unit which controls the power supply voltage to be applied to the first current supply unit;
a necessity determination unit which determines whether or not the second current needs to be adjusted; and
a current adjustment unit which adjusts the second current (a value determination unit which determines the value of the second current, a control unit which controls the supply amount of the second current, a first control unit which stops the output of the control signal, a second control unit which increases the second current until the value of the intensity signal becomes a predetermined value or greater, and a third control unit which resumes the output of the control signal).

The memory 152 stores the temperature T of the optical pickup 173.

The PCB 171 is a substrate (a circuit board) on which wiring and the like are arranged. The FPC 172 is a flexible printed circuit board. The optical pickup 173 is a member for applying the laser light to the optical disk to record and replay the information on/from the optical disk, in which the laser light source 110, a not-shown light receiving element and so on are arranged.

The laser control circuit 120 is arranged while distributed on the PCB 171, the FPC 172 and the optical pickup 173. The bias current control circuit 124 and the current amplification circuit 125 are arranged on the PCB 171. The current amplification and drive circuits AMP1 to AMP3 and the bias current adding circuits SUM1 to SUM3 are arranged on the optical pickup 173. The current amplification circuit 125 is connected to the laser diodes LD1 to LD3 via the bias current adding circuits SUM1 to SUM3. As a result, a part of the drive current Ild (the bias current Ib) can be supplied from the PCB 171 to the laser diodes LD1 to LD3 not via the current amplification and drive circuits AMP1 to AMP3. As a result, the power consumption (loss) Pamp in the current amplification and drive circuits AMP1 to AMP3 can be reduced.

The respective power consumptions Pamp [mW] and Pld [mW] in the current amplification and drive circuits AMP1 to AMP3 and in the laser diodes LD1 to LD3 are expressed by the following Expressions (1) and (2).

Pamp=(Ild−Ib)×(Vcc−Vld) Expression (1)

Pld=Ild×Vld Expression (2)

Vcc [V]: the power supply voltage supplied to the current amplification and drive circuits AMP1 to AMP3

Ild [mW]: the drive current supplied to the laser diodes LD1 to LD3 Vld [V]: the operation voltage (forward voltage) of the laser diodes LD1 to LD3

As compared to Expression (4) in a later-described comparison example, the power consumption Pamp in the current amplification and drive circuits AMP1 to AMP3 can be reduced by supplying a part of the drive current Ild as the bias current Ib from the PCB 171.

The optimal power supply voltage Vcc_opt supplied to the current amplification and drive circuits AMP1 to AMP3 is a sum of a minimum operation voltage Vamp_min of the current amplification and drive circuits AMP1 to AMP3 and the operation voltage Vld of the laser diodes LD1 to LD3 (Vcc_opt=Vamp_min+Vld). As a result, the above Expression (1) can be deformed into the following Expression (3).

Pamp=(Ild−Ib)×Vamp_min Expression (3)

As has been described, the CPU 151 detects the operation voltage Vld [V] of the laser diodes LD1 to LD3 and conducts a control such that the power supply voltage Vcc supplied from the power supply voltage generation circuit 130 coincides with the optimal power supply voltage Vcc_opt (=Vamp_min+Vld).

### Comparative Example

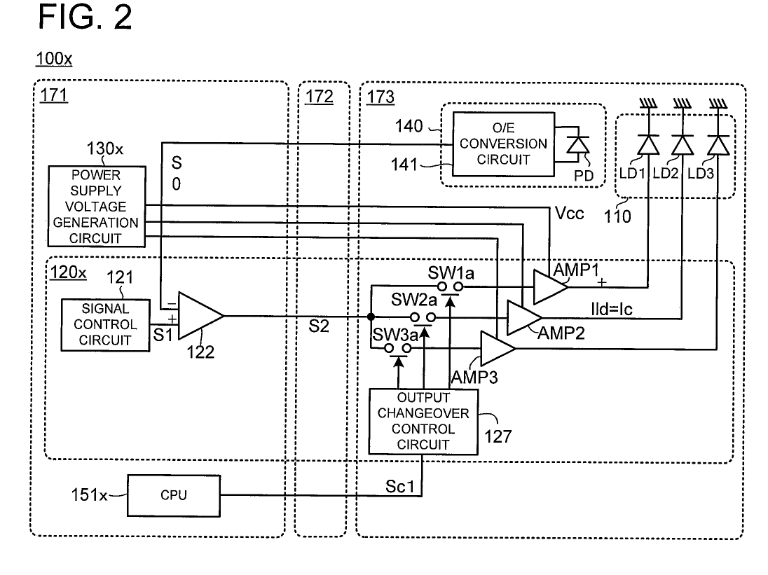

FIG. 2 is a circuit diagram showing a configuration of a laser drive circuit 100x according to a comparison example of the present invention. The laser drive circuit 100x has a laser light source 110, a laser control circuit 120x, a power supply voltage generation circuit 130x, an O/E converter 140, and a CPU 151x. These are arranged on a PCB 171, an FPC 172, and an optical pickup 173. The laser control circuit 120x supplies the drive current Ild to laser diodes LD1 to LD3. The laser diode circuit 120x does not have a configuration corresponding to the changeover switch 123, the bias current control circuit 124, the current amplification circuit 125, the operation voltage detection circuit 126, and the bias current adding circuits SUM1 to SUM3 in the laser drive circuit 100. The CPU 151x does not control the power supply voltage generation circuit 130x. In other words, the laser control circuit 120x does not generate the bias current Ib, but all the drive current Ild is outputted from current amplification and drive circuits AMP1 to AMP3.

The power consumption (loss) Pamp [mW] in the current amplification and drive circuits AMP1 to AMP3 in the comparison example is expressed by the following Expression (4).

Pamp=Ild×(Vcc−Vld) Expression (4)

For the power supply voltage Vcc in the laser drive circuit 100x, it is necessary to secure the operation voltage Vamp of the current amplification and drive circuits AMP1 to AMP3 in addition to a maximum operation voltage Vld_max of the laser diodes LD1 to LD3 during a necessary maximum intensity Ald. Accordingly, when the operation voltage Vld of the laser diodes LD1 to LD3 is small, the power supply voltage Vcc applied to the current amplification and drive circuits AMP1 to AMP3 becomes larger than necessary. As a result, an undesired power consumption (loss) Pamp and heat generation occur.

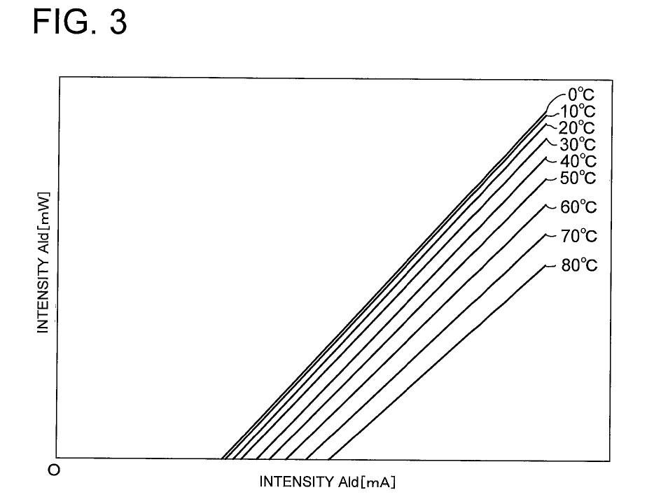

When discharge of heat in the optical pickup 173 is insufficient, the temperature of the laser diodes LD1 to LD3 increases due to the heat generation caused by the power consumption Pamp. The temperature increase causes a change in a drive current Ild-intensity Ald characteristic of the laser diodes LD1 to LD3 and deterioration (change with time) in the laser diodes LD1 to LD3. The drive current Ild-intensity Ald characteristic (light emission characteristic) of the laser diodes LD1 to LD3 is shown in FIG. 3. It is found that the light emission characteristic of the laser diodes LD1 to LD3 has temperature dependence.

Assuming that the power supply voltage Vcc is 5 [V], the drive current Ild is 50 [mA], and the operation voltage Vld is 2 [V]. In the case of the comparison example, the power consumption Pamp [mW] in the current amplification and drive circuits AMP1 to AMP3 and the power consumption Pld [mW] in the laser diodes LD1 to LD3 are expressed as follows from the above Expressions (4) and (2).

$$\begin{matrix}Pamp = Ild \times ( Vcc - Vld ) \\ = 50 \times ( 5 - 2 ) \\ = 150 [ mW ]\end{matrix}$$

$$\begin{matrix}Pld = Ild \times Vld \\ = 50 \times 2 \\ = 100 [ mW ]\end{matrix}$$

On the other hand, when the bias current Ib is 30 [mW] and the minimum operation voltage Vamp_min in the current amplification and drive circuits AMP1 to AMP3 is 2.5 [V] in the above embodiment, the power consumption Pamp [mW] and the power consumption Pld [mW] are expressed as follows from the above Expressions (1) and (2).

$$\begin{matrix}Pamp = ( Ild - Ib ) \times Vamp\_min \\ = ( 50 - 30 ) \times 2.5 \\ = 50 [ mW ]\end{matrix}$$

$$\begin{matrix}Pld = Ild \times Vld \\ = 50 \times 2 \\ = 100 [ mW ]\end{matrix}$$

In comparison of the embodiment to the comparison example, as described above, the power consumption Pld in the laser diodes LD1 to LD3 is the same. However, the power consumption Pamp in the current amplification and drive circuits AMP1 to AMP3 is greatly different. As a result, the power consumption in the optical pickup 173 is significantly reduced in the embodiment as compared to the comparison example.

### (Operation of Laser Drive Circuit 100)

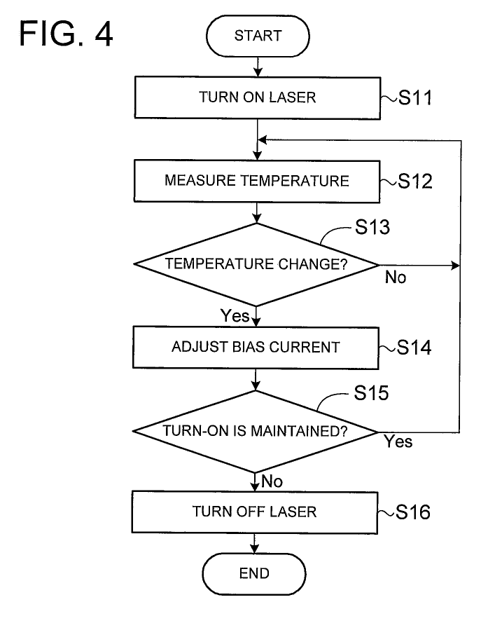

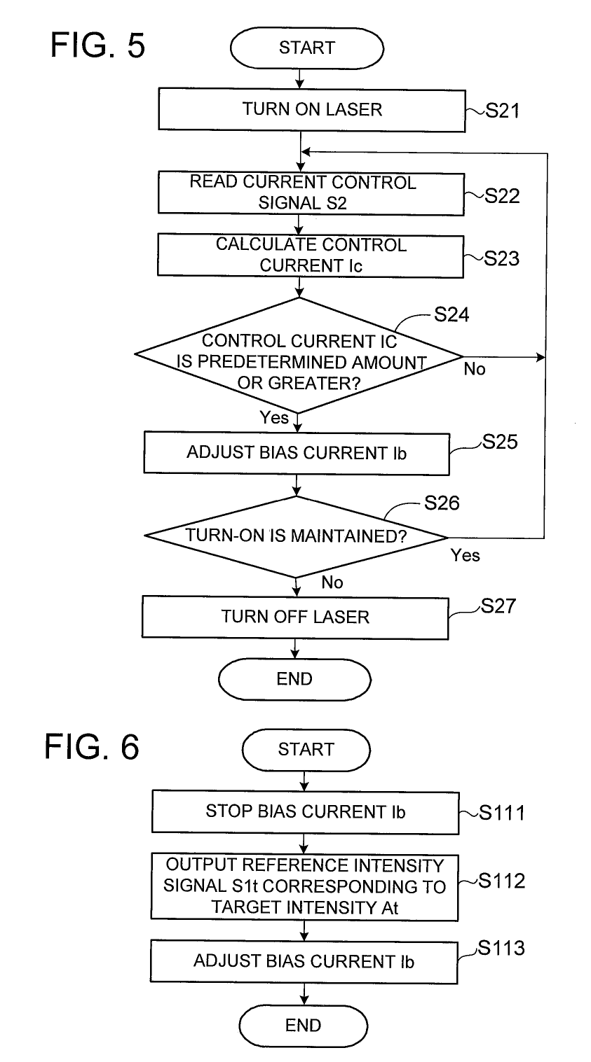

Hereinafter, the operation of the laser drive circuit 100 will be described. FIG. 4 and FIG. 5 are flowcharts showing examples of an operation procedure from turn-on to turn-off of the laser diodes LD1 to LD3. Whether or not the bias current Ib needs to be adjusted is judged, and the bias current Ib is adjusted. In the former and latter examples, whether or not the bias current Ib needs to be adjusted is judged based on the temperature and the control current Ic, respectively.

The adjustment of the bias current Ib here can be performed at any time. The bias current Ib can be adjusted, for example, at reading from or at writing into the optical disk. However, since the writing into the optical disk is made based on the premise of reading from the optical disk, the adjustment of the bias current Ib at the writing can be omitted.

A. Determination of Adjustment of Bias Current Ib based on Temperature (FIG. 4)

### (1) Turn-On of Laser Diode LD1 to LD3 (Step S11)

The laser diode LD1 to LD3 is turned on to emit the target intensity At of laser light. FIG. 6 is a flowchart showing an example of details of the turn-on procedure of the laser diode LD1 to LD3. With the bias current Ib stopped (Step S111), a reference intensity signal S1t corresponding to the target intensity At is outputted from the signal control circuit 121 (Step S112). As a result, the target intensity At of laser light is emitted from the laser diode LD1 to LD3. Thereafter, the bias current Ib is adjusted (Step S113).

The details of adjustment of the bias current Ib swill be described later. However, during the adjustment of the bias current Ib, a temperature T_bias_adj of the optical pickup 173 is measured and saved in the memory 152. In other words, the temperature T_bias_adj of the optical pickup 173 is measured every adjustment of the bias current Ib, and saved in the memory 152. In the memory 152, the temperature at the latest adjustment of the bias current Ib (update of the memory contents).

(2) Determination of Adjustment of Bias Current Ib (Steps S12 to S13) whether or not the bias current Ib needs to be adjusted is judged. In other words, when the temperature of the optical pickup 173 varies (particularly increases) by a predetermined value or greater, the adjustment of the bias current Ib is determined. Specifically, a current temperature T_current of the optical pickup 173 is measured by the temperature sensor 128 and compared to the temperature T_bias_adj saved in the memory 152. Whether or not the difference between the temperature T_current and the temperature T_bias_adj is a predetermined value or greater (the necessity of adjustment of the bias current Ib) is judged. An increase in the temperature of the optical pickup 173 means an increase in power consumption in the optical pickup 173. The bias current Ib is decrease to reduce the power consumption in the optical pickup 173.

### (3) Adjustment of Bias Current Ib (Step S14)

When the judgment in Step S13 is “Yes”, the bias current Ib is adjusted. The details thereof will be described later.

### (4) Turn-Off of Laser Diode LD1 to LD3 (Steps S15 to S16)

Whether or not the turn-on state of the laser diode LD1 to LD3 is maintained is judged (Step S15). When the judgment is “Yes”, Steps S12 to S15 are repeated. On the other hand, when the judgment is “No” (at the end of operation of the optical disk), the laser diode LD1 to LD3 is turned off.

B. Determination of Adjustment of Bias Current Ib based on Control Current Ic (FIG. 5)

### (1) Turn-On of Laser Diodes LD1 to LD3 (Step S21)

The laser diode LD1 to LD3 is turned on to emit the target intensity At of laser light. The details thereof are the same as those in Step S11 in FIG. 4 and therefore description thereof will be omitted.

### (2) Determination of Adjustment of Bias Current Ib (Steps S22 to S24)

Whether or not the bias current Ib needs to be adjusted is judged based on the control current Ic. Specifically, the CPU 151 reads the current control signal S2 and calculates the control current Ic from the current control signal S2 and an amplification factor α of the current amplification and drive circuits AMP1 to AMP3 (control current Ic=current control signal S2 (current value)×amplification factor α). Since the amplification factor α is generally a fixed value, the control current Ic can be calculated by reading the current control signal S2. When the control current Ic is a predetermined amount or greater, the adjustment of the bias current Ib is determined. In this case, it is conceivable that the power consumption in the optical pickup 713 is large. The bias current Ib is decreased to reduce the power consumption in the optical pickup 173.

### (3) Adjustment of Bias Current Ib (Step S25)

When the judgment in Step S24 is “Yes”, the bias current Ib is adjusted. The details thereof will be described later.

### (4) Turn-off of Laser Diode LD1 to LD3 (Steps S26 to S27)

Whether or not the turn-on state of the laser diode LD1 to LD3 is maintained is judged (Step S26). When the judgment is “Yes”, Steps S22 to S25 are repeated. On the other hand, when the judgment is “No”, the laser diode LD1 to LD3 is turned off.

### C. Adjustment of Bias Current Ib

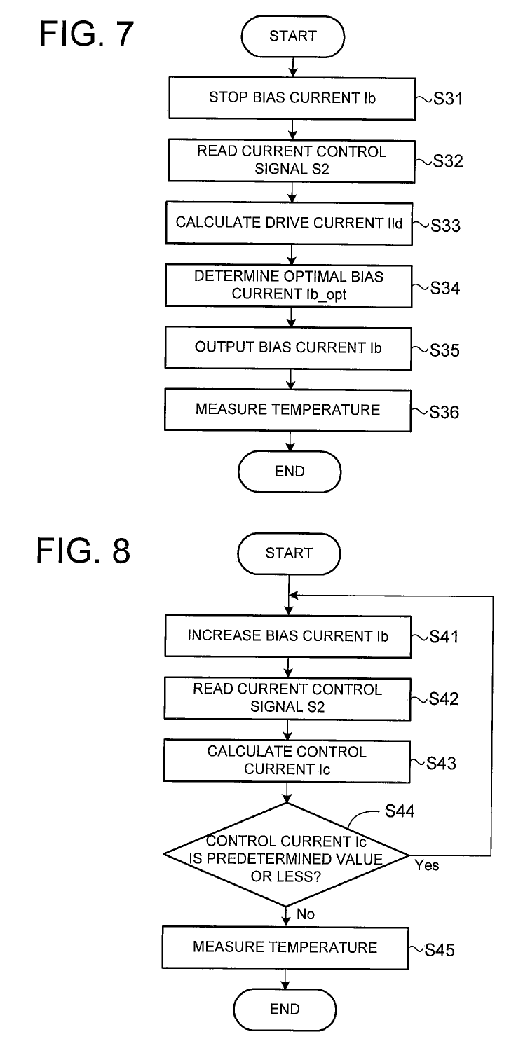

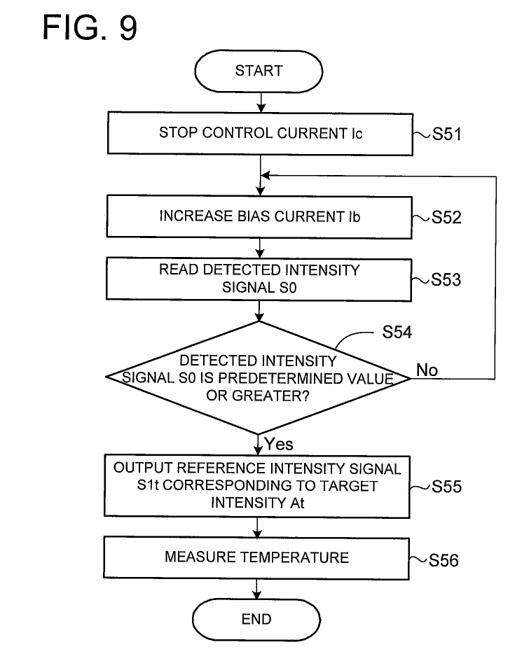

FIG. 7 to FIG. 9 are flowcharts showing examples of an adjustment procedure for the bias current Ib (adjustment procedures 1 to 3). The adjustment procedures 1 to 3 can be applied to any of Step S14 in FIG. 4, Step S25 in FIG. 5 and Step S113 in FIG. 6.

### <Adjustment Procedure 1>

### (1) Calculation of Drive Current Ild (Steps S31 to S33)

The CPU 151 reads the current control signal S2 (Step S32) and calculates the drive current Ild from the current control signal S2 and the amplification factor α of the current amplification and drive circuits AMP1 to AMP3 (Step S33).

Prior to the reading of the current control signal S2 here, the bias current Ib is temporarily stopped. In this event, all the drive current Ild is the control current Ic (drive current Ild=control current Ic=current control signal S2 (current value)×amplification factor α). Since the amplification factor α is generally a fixed value, the drive current Ild can be calculated by reading the current control signal S2.

Note that it is also possible to omit Step S31. More specifically, the drive current Ild is calculated without stopping the bias current Ib. Even if the bias current Ib is not stopped, the drive current Ild can be calculated from the present bias current Ib and the current control signal S2.

### (2) Determination and Output of Optimal Bias Current Ib_opt (Steps S34 and S35)

The optimal bias current Ib_opt is determined from the drive current Ild. The optimal bias current Ib_opt is calculated, for example, by multiplying the drive current Ild by a predetermined coefficient K (Ib_opt=K×Ild). The coefficient K indicates the ratio of the bias current Ib to the drive current Ild and can employ a fixed value. Alternatively, the coefficient K may be a function of the drive current Ild. In this case, a table indicating the drive current Ild and the coefficient K (or the bias current Ib) in a corresponding manner can be held in the memory 152 so that the optimal bias current Ib_opt can be calculated using the table.

### (3) Measurement of Temperature T_bias_adj of Optical Pickup 173 (Step S36)

The temperature T_bias_adj of the optical pickup 173 is measured by the temperature sensor 128 and held in the memory 152. This is to cope with Steps S12 and S13 in FIG. 4. Note that this Step S36 is unnecessary when the procedure in FIG. 4 is not in use.

### <Adjustment Procedure 2>

The bias current Ib is increased stepwise (Step S41), and the current control signal S2 in this event is read and the control current Ic is calculated (Steps S42 and S43). The bias current Ib is increased until the control current Ic becomes a predetermined value or less (Step S44). The increase in the bias current Ib reduces the control current Ic.

The temperature T_bias_adj of the optical pickup 173 is then measured by the temperature sensor 128 and held in the memory 152 (Step S45). This is to cope with Steps S12 and S13 in FIG. 4. Note that this Step S45 is unnecessary when the procedure in FIG. 4 is not in use.

### <Adjustment Procedure 3>

With the reference intensity signal S1 (the current control signal S2) stopped (Step S51), only the bias current Ib is increased (Step S52), and the detected intensity signal S0 from the O/E converter 140 is read (Step S53). The bias current Ib is increased until the detected intensity signal S0 becomes a predetermined reference value (the predetermined intensity Ald) or greater (Step S54).

The reference intensity signal Slt corresponding to the target intensity At (the current control signal S2) is then outputted (Step S55). As a result, the intensity Ald from the laser diode LD1 to LD3 is controlled to be the target intensity At.

The reference value of the detected intensity signal S0 in Step S54 is made here correspond to the target intensity At, whereby the most of the drive current Ild is occupied by the bias current Ib. As a result, the power consumption Pamp in the current amplification and drive circuit AMP1 to AMP3 is significantly reduced. This is suitable for the case where the intensity Ald is kept constant (for example, at replay from the optical disk). On the other hand, it is also possible to set the reference value of the detected intensity signal S0 so that the bias current Ib becomes the predetermined optimal bias current Ib_opt.

The temperature T_bias_adj of the optical pickup 173 is then measured by the temperature sensor 128 and held in the memory 152 (Step S56). This is to cope with Steps S12 and S13 in FIG. 4. Note that this Step S56 is unnecessary when the procedure in FIG. 4 is not in use.

The above-described laser drive circuit 100 according to this embodiment has the following characteristics.

A. In the laser drive circuit 100, parts are arranged on the PCB 171 and the optical pickup 173 as follows. Specifically, the power supply of the bias current Ib (the current amplification circuit 125) is disposed on the PCB 171. Further, the power supply of the control current Ic (the current amplification and drive circuits AMP1 to AMP3) and the bias current adding circuits SUM1 to SUM3 are arranged on the optical pickup 173.

Such arrangement of the parts allows a part of the drive current Ild of the laser diodes LD1 to LD3 to be supplied as the bias current Ib from the PCB 171. Accordingly, the power consumption Pamp in the current amplification and drive circuits AMP1 to AMP3, that is, the power consumption on the optical pickup 173 can be reduced. Accordingly, the temperature increase near the laser diodes LD1 to LD3 and in the laser control circuit 120 can be suppressed. As a result, the following advantages (1) to (3) can be presented.

(1) The deterioration in the characteristics (change with time) of the laser diodes LD1 to LD3 due to the temperature increase can be reduced.

(2) The amount of change in current at ON/OFF of optical pulse for write into the optical disk is decreased. As shown in FIG. 3, when the laser diodes LD1 to LD3 increase in temperature, the inclination of a graph of the drive current Ild-intensity Ald decreases in which the amount of change in current at ON/OFF of optical pulse increases. When the laser diodes LD1 to LD3 are kept at a low temperature, the amount of change in current at ON/OFF of optical pulse is relatively small. As a result, the heat generation of the laser diodes LD1 to LD3 at recording can be reduced as well as the rise time and fall time of the optical pulse are decreased. As a result, the reliability of recording into the optical disk is improved.

(3) The necessity of heat release from the optical pickup 173 is decreased. In other words, the heat release area in the optical pickup 173, that is, the weight of the optical pickup 173 can be reduced. As a result, the access speed of the optical pickup 173 can be improved.

B. The power supply voltage Vcc supplied to the current amplification and drive circuits AMP1 to AMP3 is controlled corresponding to the operation voltage Vld of the laser diodes LD1 to LD3. As a result, the power consumption in the current amplification and drive circuits AMP1 to AMP3 can be reduced. The operation voltage Vld can be detected using, for example, the voltage Vb at the output end of the current amplification circuit 125.

C. The bias current Ib is decreased corresponding to the temperature rise of the optical pickup 173 and the increase in the control current Ic, whereby the power consumption in the optical pickup 173 can be suppressed.

### OTHER EMBODIMENTS

The embodiment of the present invention is not limited to the above-describe embodiment, but can be extended or changed, and the extended and changed embodiments are also included in the technical scope of the present invention.

What is claimed is:

1. An optical disk device, comprising:
a light emitting element which applies light to an optical disk;
a light detection unit which receives the light emitted from the light emitting element and outputs an intensity signal corresponding to an intensity of the light emitting element;
a difference detection unit which generates a control signal based on a difference between the intensity signal and a reference intensity signal;
a first current supply unit which supplies a first current based on the control signal;
a second current supply unit which supplies a second current;
a current adding unit which adds the first and second currents to generate a third current and supplies the third current to the light emitting element;
an optical pickup on which the first current supply unit and the adding unit are placed; and
a circuit board on which the second current supply unit is placed.

2. The optical disk device as set forth in claim 1, further comprising:
a voltage detection unit which detects an operation voltage of the light emitting element; and
a voltage control unit which controls a power supply voltage applied to the first current supply unit based on the operation voltage.

3. The optical disk device as set forth in claim 1, further comprising:
a necessity determination unit which determines whether or not the second current needs to be adjusted, based on a temperature of the pickup; and
a current adjustment unit which adjusts the second current based on the determination.

4. The optical disk device as set forth in claim 1, further comprising:
a necessity determination unit which determines whether or not the second current needs to be adjusted, based on the first current; and
a current adjustment unit which adjusts the second current based on the determination.

5. The optical disk device as set forth in claim 4,
wherein the current adjustment unit includes:
a value determination unit which determines a value of the second current, based on the first current; and
a control unit which controls a supply amount of the second current according to the value.

6. The optical disk device as set forth in claim 4,
wherein the current adjustment unit controls the second current supply unit to increase the second current until the first current becomes a predetermined value or less.

7. The optical disk device as set forth in claim 4,
wherein the current adjustment unit includes:
a first control unit which controls the difference detector to stop the output of the control signal;
a second control unit which controls the second current supply unit to increase the second current until the value of the intensity signal becomes a predetermined value or greater; and
a third control unit which controls the difference detector to resume the output of the control signal.

8. A method of controlling a light emitting element which applies light to an optical disk, comprising:
receiving the light emitted from the light emitting element and outputting an intensity signal corresponding to an intensity of the light emitting element;
generating a control signal based on a difference between the intensity signal and a reference intensity signal;
supplying a first current based on the control signal from top of an optical pickup;
supplying a second current from top of a circuit board; and
adding the first and second currents to generate a third current on top of the optical pickup and supplying the third current to the light emitting element.

9. The method of controlling a light emitting element as set forth in claim 8, further comprising:
detecting an operation voltage of the light emitting element; and
controlling a power supply voltage applied to a first current supply unit based on the operation voltage.

10. The method of controlling a light emitting element as set forth in claim 8, further comprising:
determining whether or not the second current needs to be adjusted, based on a temperature of the pickup; and
adjusting the second current based on the determination.

11. The method of controlling a light emitting element as set forth in claim 8, further comprising:
determining whether or not the second current needs to be adjusted, based on the first current; and
adjusting the second current based on the determination.

12. The method of controlling a light emitting element as set forth in claim 11,
wherein the adjusting the current includes:
determining a value of the second current, based on the first current; and
controlling a supply amount of the second current according to the value.

13. The method of controlling a light emitting element as set forth in claim 11,
wherein in the adjusting the current, a second current supply unit is controlled to increase the second current until the first current becomes a predetermined value or less.

14. The method of controlling a light emitting element as set forth in claim 11,
wherein the adjusting the current includes:
controlling a difference detector to stop the output of the control signal;
controlling a second current supply unit to increase the second current until the value of the intensity signal becomes a predetermined value or greater; and
controlling the difference detector to resume the output of the control signal.
